(19) United States
(12) Patent Application Publication
(10) Pub. No.: US 2021/0161271 A1
(43) Pub. Date: Jun. 3, 2021

(54) TABLE LAMP SHAPED MANICURE DEVICE

(71) Applicant: RIGHTNOW CO., LTD, New Taipei City (TW)

(72) Inventor: KUO-CHANG CHENG, New Taipei City (TW)

(21) Appl. No.: 16/698,987

(22) Filed: Nov. 28, 2019

(51) Int. Cl. A45D 29/00; B05D 3/06

(52) U.S. Cl. CPC A45D 29/00; B05D 3/067

(57) ABSTRACT

A table lamp shaped manicure device is provided, comprising a base, a lamp body, a substrate, at least an ultraviolet light-emitting diode, an infrared sensor, and a control module; the lamp body comprising a support portion and a light-emitting portion; a bottom end of the support portion being disposed on the base, and the light-emitting portion being disposed at a top end of the support portion; the substrate being disposed inside the light-emitting portion, the at least an ultraviolet light-emitting diode being disposed on the substrate; the infrared sensor being disposed on the substrate, and located on the same side of the substrate as the at least an ultraviolet light-emitting diode, and having a sensing range; the control module being disposed inside the base and electrically connected to the at least an ultraviolet light-emitting diode and the infrared sensor.

### BACKGROUND OF THE INVENTION

### 1. Field of the Invention

The present invention relates generally to a manicure device, and more particularly to a table lamp shaped manicure device for curing a UV liquid glue applied to a fingernail or a toenail.

### 2. The Prior Arts

For people who love beauty, the pursuit of beauty includes not only clothing, accessories, but also the decorations and elaborated painting on fingernails or toenails, which evolved into manicure or pedicure practice.

Traditional nail painting is the application of nail polish on fingernails or toenails, with the down side that the air drying for the nail polish would take at least an hour. With the progress in the industry, nail painting technology is more diverse. One of the techniques is to apply a UV-curable resin, commonly known as UV liquid glue, to the fingernails or toenails, and then put the hands or feet into a chamber inside a manicure device for irradiation of ultraviolet light. As such, the UV liquid glue is cured quickly in just a few minutes under UV light and can last from two weeks to a month.

Recently, a very popular trend for the manicurist in the manicure market is apply extending nail pieces directly on the user's fingernails, the so-called “Yan-jia”, which can be literally translated as extending nails.

When a manicurist is busy, the impatient customer is usually reluctant to wait, and will often put the finger or toe with extending nail piece into the chamber inside the manicure device on their own, and press the switch to activate the ultraviolet light emitting diode for curing.

However, the chamber inside a conventional manicure device is usually surrounded by a cover and a base. During the process of the customer's finger or toe extending into the chamber inside the manicure device, the extending nail piece, the stud diamond, and the other jewelry are easy to collide with the cover and collapse or even fall off, so that the manicurist's work is damaged and the process must start all over again. This situation occurs more frequently when performing the work of extending nail.

Furthermore, the cover of the conventional nail device usually is shaped like a dome, so that the overall size of the manicure device is bulky, difficult for storage or to carry around, and the pedicure work of the toenails becomes very inconvenient.

In addition, since the conventional manicure device does not provide a sunlight or white-light environment, a white-light table lamp must be placed on the work bench when the conventional manicure device is in the process of micro-curing the UV liquid glue applied to the fingernail or the toenail. The manicurist and the customer can both observe the decoration and beautification of the fingernails or toenails by the white-light provided by the white-light table lamp.

### SUMMARY OF THE INVENTION

A primary objective of the present invention is to provide a table lamp shaped manicure device, which is in the form of a lamp, without a cover, and able to automatically sense the finger or toe to enter or leave the sensing range to turn on and off the ultraviolet light-emitting diode, so that the manicurist when affixing extending nail piece or sticking diamonds or ornaments, can conveniently move the customer's fingers or toes to the underside of the ultraviolet light-emitting diodes to automatically perform micro-curing to prevent extending nail piece and stud diamonds or jewelry from dropping.

Another objective of the present invention is to provide a table lamp shaped manicuring device, which can be unfolded into a lamp to reduce the volume for storage and carrying.

Another objective of the present invention is to provide a table lamp shaped manicure device which includes a swan neck, convenient for a manicurist to grasp and move at will, and convenient in pedicure for toenails.

A further objective of the present invention is to provide a table lamp shaped manicure device capable of simultaneously providing ultraviolet light and white-light to provide, in addition to micro-curing of UV liquid glue applied to fingernails or toenails, also for the manicurists and customers to observe the decoration and beautification of fingernails or toenails.

To achieve the foregoing objectives, the present invention provides a table lamp shaped manicure device, comprising a base, a lamp body, a substrate, at least an ultraviolet light-emitting diode, an infrared sensor, and a control module; the lamp body comprising a support portion and a light-emitting portion; a bottom end of the support portion being disposed on the base, and the light-emitting portion being disposed at a top end of the support portion; the substrate being disposed inside the light-emitting portion, the at least an ultraviolet light-emitting diode being disposed on the substrate; the infrared sensor being disposed on the substrate, and located on the same side of the substrate as the at least an ultraviolet light-emitting diode, and having a sensing range; the control module being disposed inside the base and electrically connected to the at least an ultraviolet light-emitting diode and the infrared sensor.

Wherein, when the infrared sensor senses a user's finger or toe entering a sensing range, the infrared sensor transmits an activation signal to the control module, and the control module turns on the at least an ultraviolet light-emitting diode according to the activation signal.

Wherein, when the infrared sensor senses a user's finger or toe exiting a sensing range, the infrared sensor transmits a deactivation signal to the control module, and the control module turns off the at least an ultraviolet light-emitting diode according to the deactivation signal.

As such, the table lamp shaped manicure device of the present invention is in the form of a lamp, without a cover, and able to automatically sense the finger or toe to enter or leave the sensing range to turn on and off the ultraviolet light-emitting diode, so that the manicurist when affixing extending nail piece or sticking diamonds or ornaments, can conveniently move the customer's fingers or toes to the underside of the ultraviolet light-emitting diodes to automatically perform micro-curing to prevent extending nail piece and stud diamonds or jewelry from dropping.

In an embodiment of the present invention, the base, the support portion and the light-emitting portion are all plate-shaped, the bottom end of the support portion is pivotally disposed at one end of the base, and the light-emitting portion is pivotally disposed at a top end of the support portion; a plurality of holes are formed in a bottom surface of the light-emitting portion, and the at least an ultraviolet light-emitting diode and the infrared sensor are disposed corresponding to the holes; as such, the table lamp shaped manicure device of the present invention can be expanded into a lamp shape, and can be folded to reduce the volume for convenient storage and carrying.

Preferably, two first through holes are disposed at one end of the base, two first pivot holes are disposed at the bottom end of the support portion, two second pivot holes are disposed at the top end of the support portion, and two second through holes are disposed at one end of the light-emitting portion; the table lamp shaped manicure device further comprises a first pivoting portion and four first pivot axes, and the two ends of the first pivoting portion are respectively disposed with four first insertion holes, wherein the two ends of the two first pivot axes are respectively disposed at the two of the first through holes of the base and two of the first insertion holes of the first pivoting portion, and the two ends of the other two first pivot axes are respectively disposed at the other two first insertion holes of the first pivoting portion and the two second pivot holes of the support portion; and the table lamp shaped manicure device further comprises a second pivoting portion and four second pivot axes, the two ends of the second pivoting portion are respectively disposed with four second insertion holes, wherein the two ends the two second pivot axes are respectively disposed at the two of the second through holes of the support and two of the second insertion holes of the second pivoting portion, and the two ends of the other two second pivot axes are respectively disposed at the other two second insertion holes of the second pivoting portion and the two second through holes of the light-emitting portion.

In an embodiment of the present invention, the support portion has a rod shape and is perpendicular to the base, and the light-emitting portion has a curved shape and is integrally formed with the support portion, and the at least an ultraviolet light-emitting diode and the infrared sensor are disposed at a free end of the light-emitting portion; as such, the table lamp shaped manicure device of the present creation has a swan neck shape, convenient for a manicurist to grasp and move at will, and convenient in pedicure for toenails.

In an embodiment of the present invention, each of the support portion and the light-emitting portion has an elongated shape; wherein the table lamp shaped manicure device further comprises at least a white light-emitting diode, the at least a white light-emitting diode is disposed on the substrate, and the at least an ultraviolet light-emitting diode and the infrared sensor are located on the same side of the substrate; and wherein the bottom surface of the light-emitting portion is disposed with a plurality of holes, the at least an ultraviolet light-emitting diode, the infrared sensor, and the at least a white light-emitting diodes pass through the holes respectively; as such, the table lamp shaped manicure device of the present invention is capable of simultaneously providing ultraviolet light and white-light to provide, in addition to micro-curing of UV liquid glue applied to fingernails or toenails, also for the manicurists and customers to observe the decoration and beautification of fingernails or toenails.

Preferably, the at least a white light-emitting diode is located between the at least an ultraviolet light-emitting diode and a rear end of the light-emitting portion.

Preferably, the table lamp shaped manicure device further comprises at least a battery disposed inside the base and electrically connected to the control module; and wherein the base comprises at least a USB socket, and the at least a USB socket is electrically connected to the control module.

Preferably, the base comprises two USB sockets, the two USB sockets are of different types.

Preferably, the base comprises a power socket, and the power socket is electrically connected to the control module.

Preferably, the infrared sensor is located between a front end of the light-emitting portion and the at least an ultraviolet light-emitting diode.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic expanded view according to the first embodiment of the present invention;

FIG. 2 is a dissected view according to the first embodiment of the present invention;

FIG. 3 is a dissected view from a different angle according to the first embodiment of the present invention;

FIG. 4 is a schematic view of the first embodiment of the present invention placed on a table to provide a user's hand to enter to cure the UV liquid glue;

FIG. 5 is a schematic folded view of the first embodiment of the present invention

FIG. 6 is a side view according to the second embodiment of the present invention;

FIG. 7 is a schematic view of the second embodiment of the present invention placed on a table to provide a user's hand to enter to cure the UV liquid glue;

FIG. 8 is a side view according to the third embodiment of the present invention; and

FIG. 9 is a schematic view of the third embodiment of the present invention placed on a table to provide a user's hand to enter to cure the UV liquid glue.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

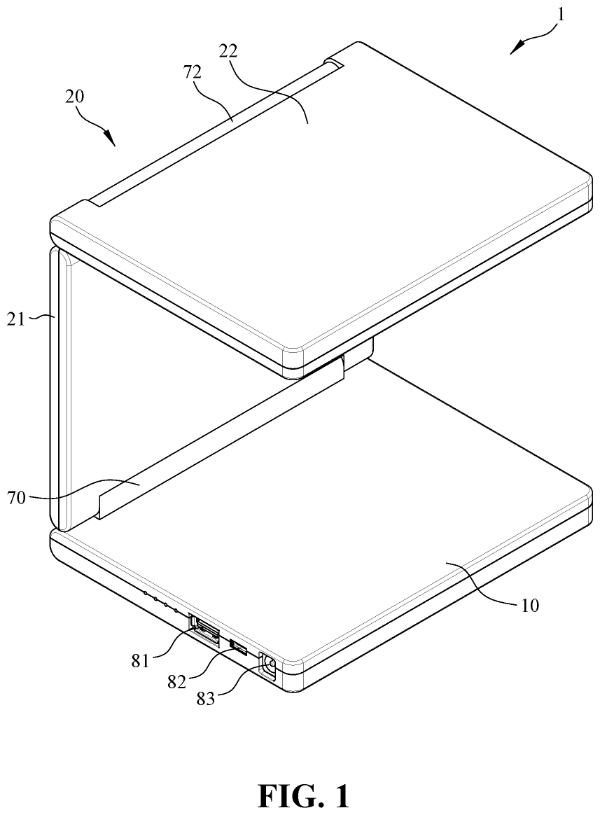

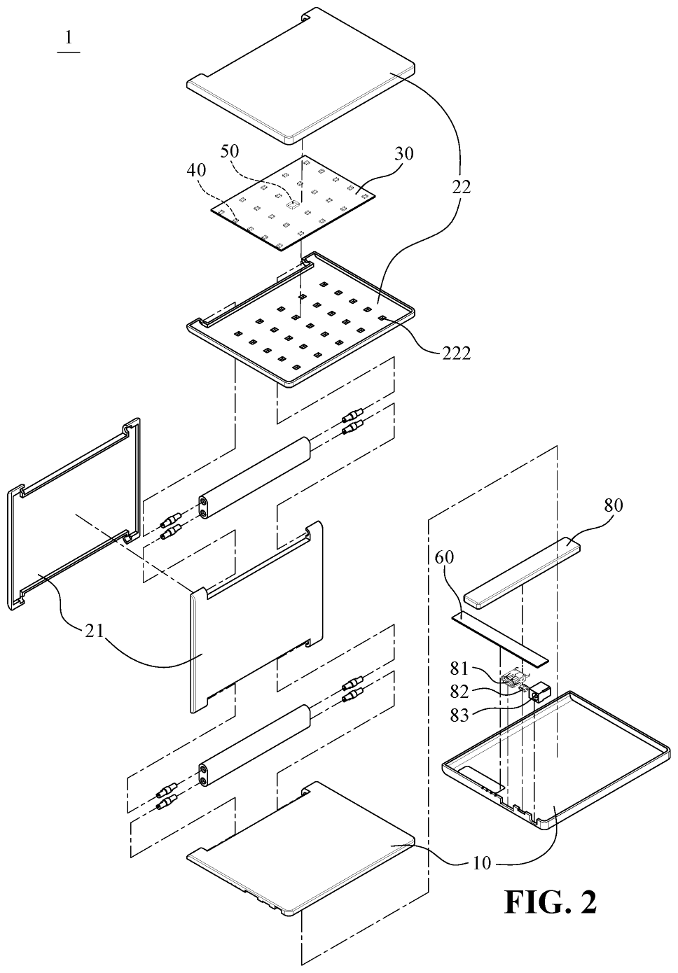

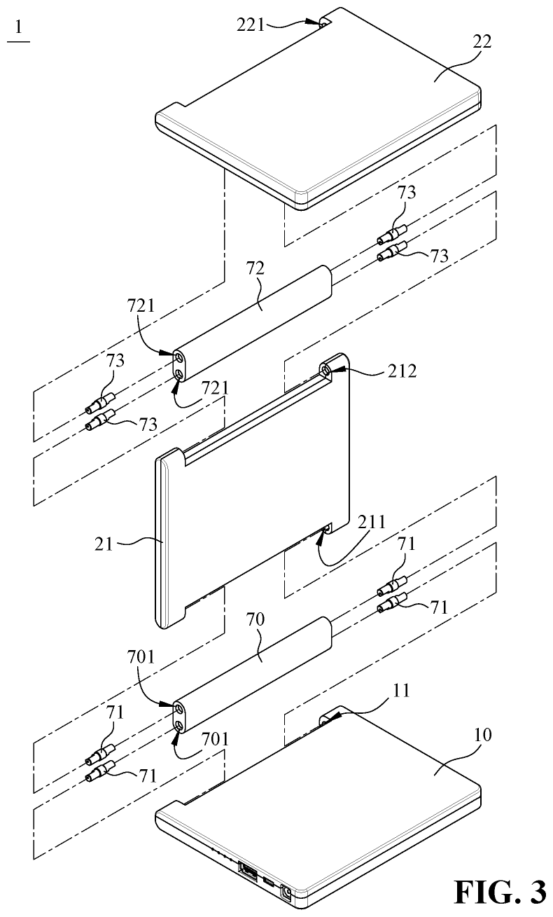

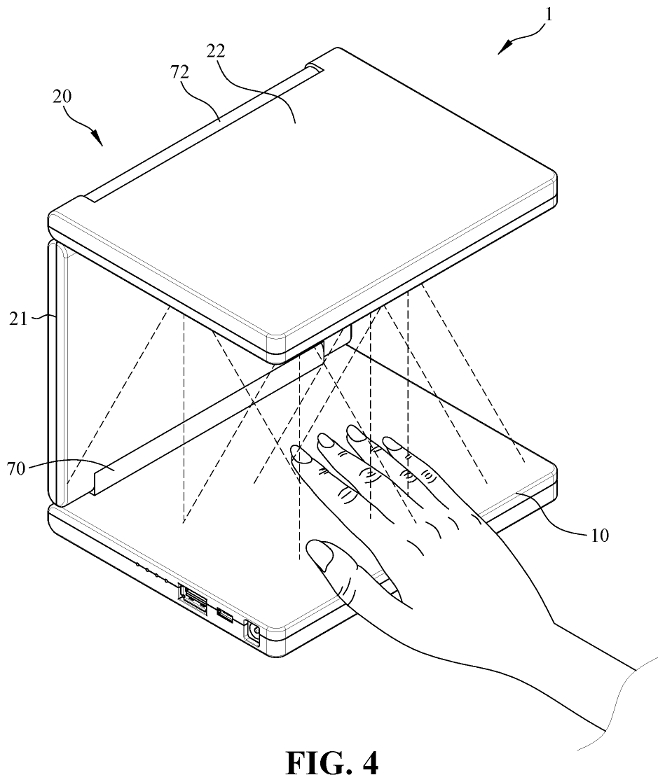

Referring to FIG. 1 to FIG. 4, FIG. 1 is a schematic expanded view according to the first embodiment of the present invention; FIG. 2 is a dissected view according to the first embodiment of the present invention; FIG. 3 is a dissected view from a different angle according to the first embodiment of the present invention; and FIG. 4 is a schematic view of the first embodiment of the present invention placed on a table to provide a user's hand to enter to cure the UV liquid glue. The present invention provides a table lamp shaped manicure device 1, comprising a base 10, a lamp body 20, a substrate 30, a plurality of ultraviolet light-emitting diodes 40, an infrared sensor 50, and a control module 60. The lamp body 20 comprises a support portion 21 and a light-emitting portion 22; a bottom end of the support portion 21 is disposed on the base 10, and the light-emitting portion 22 is disposed at a top end of the support portion 21. The substrate 30 is disposed inside the light-emitting portion 22, and the plurality of ultraviolet light-emitting diodes 40 are disposed on the substrate 39. The infrared sensor 50 is disposed on the substrate 30 and located on the same side of the substrate 30 as the plurality of ultraviolet light-emitting diodes 40, and has a sensing range. The control module 60 is disposed inside the base 10 and electrically connected to the plurality of ultraviolet light-emitting diodes 40 and the infrared sensor 50.

In the first embodiment of the present invention, the base 10, the support portion 21 and the light-emitting portion 22 are all plate-shaped, the bottom end of the support portion 21 is pivotally disposed at one end of the base 10, and the light-emitting portion 22 is pivotally disposed at a top end of the support portion 21. More specifically, two first through holes 11 are disposed at one end of the base 10, two first pivot holes 211 are disposed at the bottom end of the support portion 21, two second pivot holes 212 are disposed at the top end of the support portion 21, and two second through holes 221 are disposed at one end of the light-emitting portion 22. The table lamp shaped manicure device 1 further comprises a first pivoting portion 70 and four first pivot axes 71, and the two ends of the first pivoting portion 70 are respectively disposed with four first insertion holes 701, wherein the two ends of the two first pivot axes 71 are respectively disposed at the two of the first through holes 11 of the base 10 and two of the first insertion holes 701 of the first pivoting portion 70, and the two ends of the other two first pivot axes 71 are respectively disposed at the other two first insertion holes 701 of the first pivoting portion 70 and the two second pivot holes 211 of the support portion 21. The table lamp shaped manicure device 1 further comprises a second pivoting portion 72 and four second pivot axes 73, the two ends of the second pivoting portion 72 are respectively disposed with four second insertion holes 721, wherein the two ends the two second pivot axes 73 are respectively disposed at the two of the second pivot holes 212 of the support portion 21 and two of the second insertion holes 721 of the second pivoting portion 72, and the other two ends of the other two second pivot axes 73 are respectively disposed at the other two second insertion holes 721 of the second pivoting portion 72 and the two second through hole 221 of the light-emitting portion 22. The support portion 21 rotates between an expanded position and a folded position relative to the base 10 through the first pivoting portion 70 and the first pivot axes 71. Through the second pivoting portion 72 and the second pivot axes 73, the light-emitting portion 22 rotates with respect to the support portion 21 between an expanded position and a folded position.

In the first embodiment of the present invention, a plurality of holes 222 are formed in a bottom surface of the light-emitting portion 22, and the plurality of ultraviolet light-emitting diodes 40 and the infrared sensor 50 are disposed corresponding to the holes 222. More specifically, the infrared sensor 50 is located near the center of the light-emitting section 22. The infrared light emitted by the infrared sensor 50 is emitted outwards through the corresponding hole 222, and the ultraviolet light emitted by the ultraviolet light-emitting diodes 40 is emitted outwards through the corresponding hole 222.

The following will further describe how the first embodiment of the present invention cures the UV liquid glue applied to the fingernails or toenails in conjunction with the drawings.

First, as shown in FIG. 1, the support portion 21 is rotated with respect to the base 10 to an expanded, i.e., deployment, position through the first pivoting portion 70 and the first pivot axes 71, and the light-emitting portion 22 is rotated with respect to the support portion 21 to an expanded through the second pivoting portion 72 and the second pivot axes 73. As such, the first embodiment of the present invention is unfolded into a table lamp shape.

Next, as shown in FIG. 4, the base 10 is placed on a table, and the fingers or toes of the user are moved under the light-emitting portion 22. When the infrared sensor 50 senses the user's finger or toe entering the sensing range, the infrared sensor 50 sends an activation signal to the control module 60, and the control module 60 turns on the ultraviolet light-emitting diodes 40 according to the activation signal. At this point, the ultraviolet light emitted from the ultraviolet light-emitting diodes 40 irradiates the UV liquid glue on the fingernails or toenails, so that the UV liquid glue is rapidly cured.

After the UV liquid glue is completely cured, the user's fingers or toes leave from under the light-emitting portion 22. When the infrared sensor 50 senses the user's finger or toe exiting the sensing range, the infrared sensor 50 sends a deactivation signal to the control module 60, and the control module 60 turns off the ultraviolet light-emitting diodes 40 according to the deactivation signal.

As such, when the first embodiment of the present invention is expanded, the embodiment is in the form of a lamp, without a cover, and able to automatically sense the finger or toe to enter or leave the sensing range by infrared sensor 50 to turn on and off the ultraviolet light-emitting diode 40, so that the manicurist when affixing extending nail piece or sticking diamonds or ornaments, can conveniently move the customer's fingers or toes to the underside of the light-emitting portion 22 to automatically perform micro-curing to prevent extending nail piece and stud diamonds or jewelry from dropping.

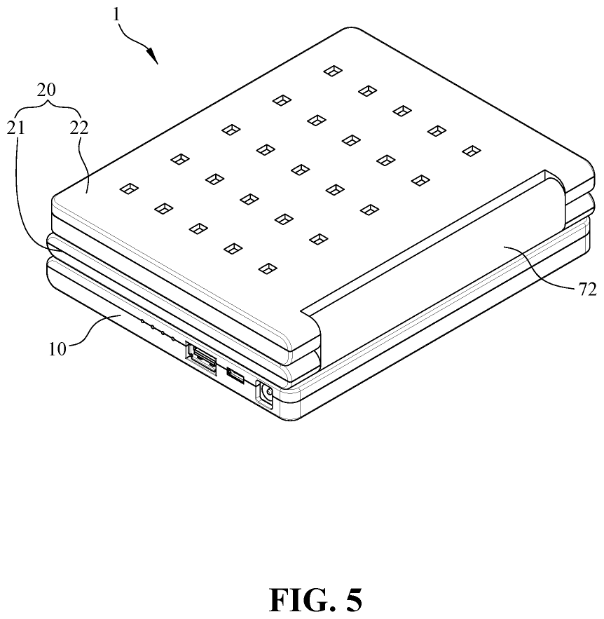

Finally, as shown in FIG. 5, the support portion 21 is rotated with respect to the base 10 through the first pivoting portion 70 and the first pivot axes 71 to the folded position, and the light-emitting portion 22 is rotated with respect to the supporting portion 21 through the second pivoting portion 72 and the second pivot axes 73 to the folded position; as such, the first embodiment of the present invention can be folded to reduce the volume for convenient storage and carrying.

As shown in FIG. 3, the table lamp shaped manicure device 1 further comprises a battery 80, which is disposed inside the base 10 and is electrically connected to the control module 60. The battery 80 may be a disposable battery or a rechargeable battery. The base 10 comprises two USB sockets 81 and 82. The two USB sockets 81 and 82 are electrically connected to the control module 60 and are of different types. As shown in FIG. 1, the USB socket 81 is Type A, for a USB plug (not shown) of the type A to be inserted therein; the USB socket 82 is Micro-B, for a USB plug of type Micro-B (not shown). In other embodiments, the two USB sockets 81 and 82 can also be of other types. A USB transmission cable (not shown) is inserted into a USB socket 81, 82 of the same type through a USB plug at one end, and a USB socket of a transformer (not shown) through the USB plug at the other end, a USB socket for a mobile power supply (not shown) or a USB socket for a computer (not shown). The plug of the transformer is further inserted in the socket that provides the mains electricity. The mains electricity, mobile power or the computer can transfer power to the battery through the USB transmission line to charge the battery. The USB plug at the other end of the USB cable can also be inserted into a USB table lamp (not shown) to provide white light to facilitate observation of the decoration and beautification of fingernails or toenails. The USB plug at the other end of the USB cable can also be inserted into a USB nail polisher (not shown) to facilitate the manicurist to operate the USB nail polisher to further modify the user's fingernails or toenails.

In the first embodiment of the present invention, the base 10 comprises a power socket 83, and the power socket 83 is electrically connected to the control module 60. A power cord (not shown) is plugged into the power socket 83 through a power supply connector at one end thereof, and is plugged into a socket (not shown in the figure) that provides mains electricity through a power plug at the other end. The mains electricity can transmit power to the battery through the power cord to charge the battery or directly supply power to the control module 60.

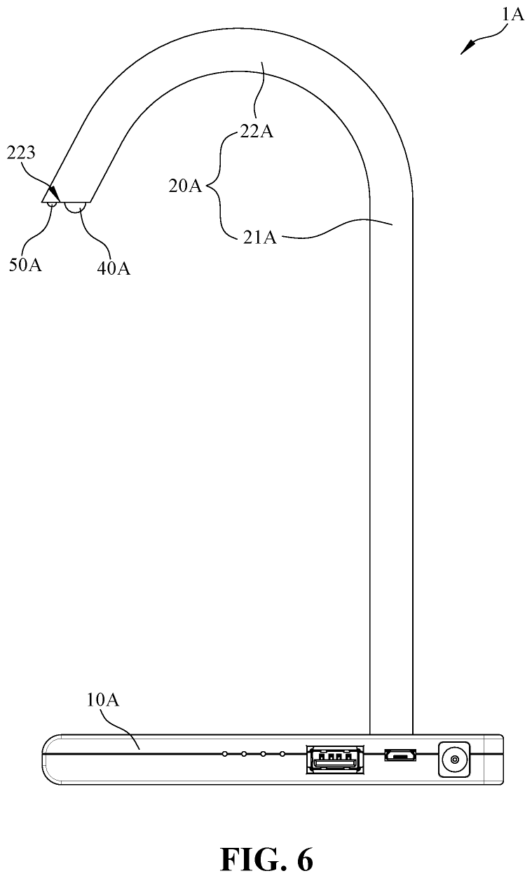

Referring to FIG. 6, FIG. 6 is a side view of the second embodiment of the present invention. The difference between the table lamp shaped manicure device 1A of the second embodiment of the present invention and the table lamp shaped manicure device 1 of the first embodiment of the present invention is that the shape of the lamp body 20A is different from the shape of the lamp body 20. More specifically, the support portion 21A has a rod shape and is perpendicular to the base 10A, the light-emitting portion 22A has a bent-rod shape and is integrally formed with the support portion 21A, and the ultraviolet light-emitting diode 40A and the infrared sensor 50A are provided at a free end 223 of the light-emitting portion 22A. In other words, the shape of the lamp body 20A is like a swan neck. Furthermore, because the light-emitting portion 22A is in the shape of a bent-rod, the free end 223 of the light-emitting portion 22A has a limited area and can only have two holes. The number of UV light-emitting diode 40A is only one. The infrared sensor 50A emits light through one of the holes, and the ultraviolet light-emitting diode 40A emits through the other hole. In addition, the infrared sensor 50A is located between the front end of the light-emitting portion 22A and the ultraviolet light-emitting diode 40A.

The following will further describe how to cure the UV liquid glue applied to the fingernails or toenails according to the second embodiment of the present invention with the drawings.

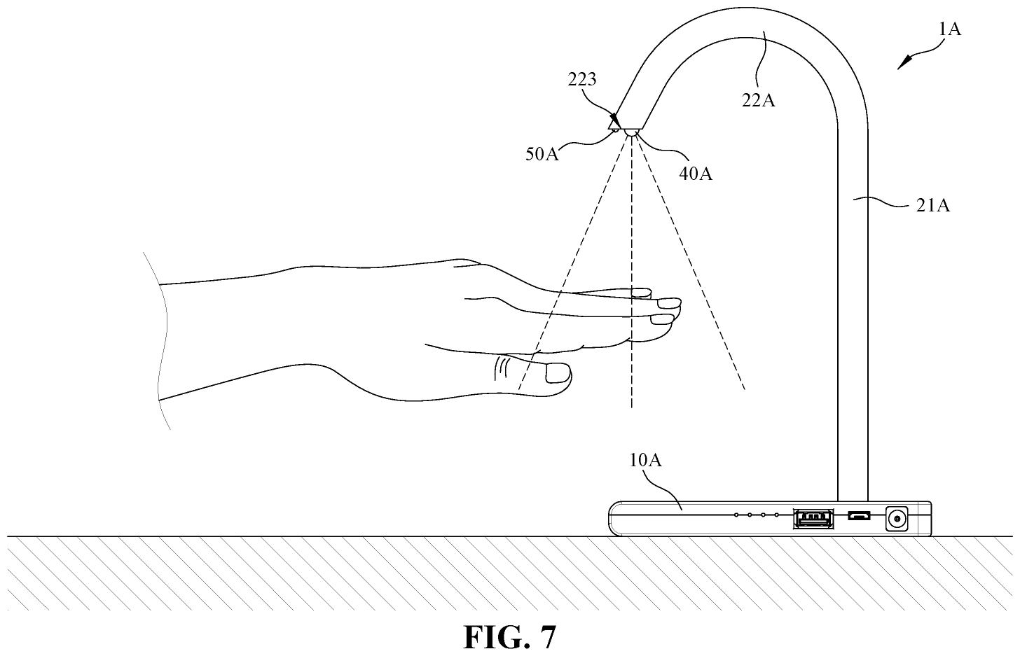

First, as shown in FIG. 7, the base 10A is placed on a table, and the fingers or toes of the user are moved under the light-emitting portion 22A. When the infrared sensor 50A senses the user's finger or toe entering the sensing range, the infrared sensor 50A sends an activation signal to the control module, and the control module turns on the ultraviolet light-emitting diode 40A according to the activation signal. At this point, the ultraviolet light emitted from the ultraviolet light-emitting diode 40A irradiates the UV liquid glue on the fingernails or toenails, so that the UV liquid glue is rapidly cured.

After the UV liquid glue is completely cured, the user's fingers or toes leave from under the light-emitting portion 22A. When the infrared sensor 50A senses the user's finger or toe exiting the sensing range, the infrared sensor 50A sends a deactivation signal to the control module, and the control module turns off the ultraviolet light-emitting diode 40A according to the deactivation signal.

As such, the table lamp shaped manicure device 1A of the second embodiment of the present invention is in the form of a sawn neck, without a cover, and able to automatically sense the finger or toe to enter or leave the sensing range by infrared sensor 50A to turn on and off the ultraviolet light-emitting diode 40A, so that the manicurist when affixing extending nail piece or sticking diamonds or ornaments, can conveniently move the customer's fingers or toes to the underside of the light-emitting portion 22A to automatically perform micro-curing to prevent extending nail piece and stud diamonds or jewelry from dropping.

Furthermore, the table lamp shaped manicure device 1A of the second embodiment of the present invention is shaped like a swan neck, which is convenient for a manicurist to grasp and move freely to enable convenient working on fingernails or toenails.

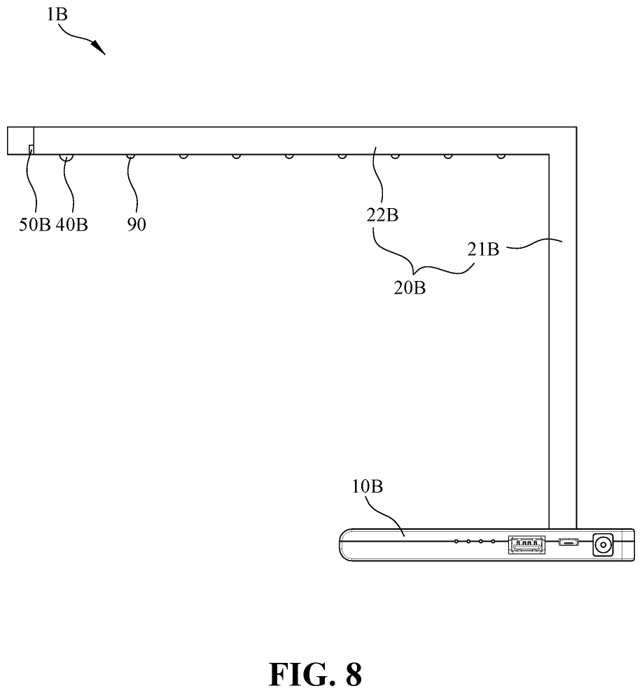

Referring to FIG. 8, FIG. 8 is a side view of the third embodiment of the present invention. The difference between the table lamp shaped manicure device 1B of the third embodiment of the present invention and the table lamp shaped manicure device 1 of the first embodiment of the present invention as well as the table lamp shaped manicure device 1A of the second embodiment of the present invention is that the shape of the lamp body 20B is different from the shape of the lamp body 20 and lamp body 20A. More specifically, each of the support portion 21B and the light-emitting portion 22B has an elongated shape. Furthermore, the infrared sensor 50B is located between the front end of the light-emitting portion 22B and the ultraviolet light-emitting diode 40B. Furthermore, the table lamp shaped manicure device 1B further comprises a plurality of white light-emitting diodes 90, the plurality of white light-emitting diodes 90 is disposed on the substrate, and the plurality of white light-emitting diodes 90 and the infrared sensor 50B are located on the same side of the substrate, and is located between the rear end of the light-emitting portion 22B and the ultraviolet light-emitting diodes 40B. The white light-emitting diodes 90, the infrared sensor 50B and the ultraviolet light-emitting diodes 40B emit light through the holes respectively. In other words, the table lamp shaped manicure device 1B of the third embodiment of the present invention is a common white-light table lamp integrated with the ultraviolet light-emitting diodes 40B.

The following will further describe how to cure the UV liquid glue applied to the fingernails or toenails according to the third embodiment of the present invention with the drawings.

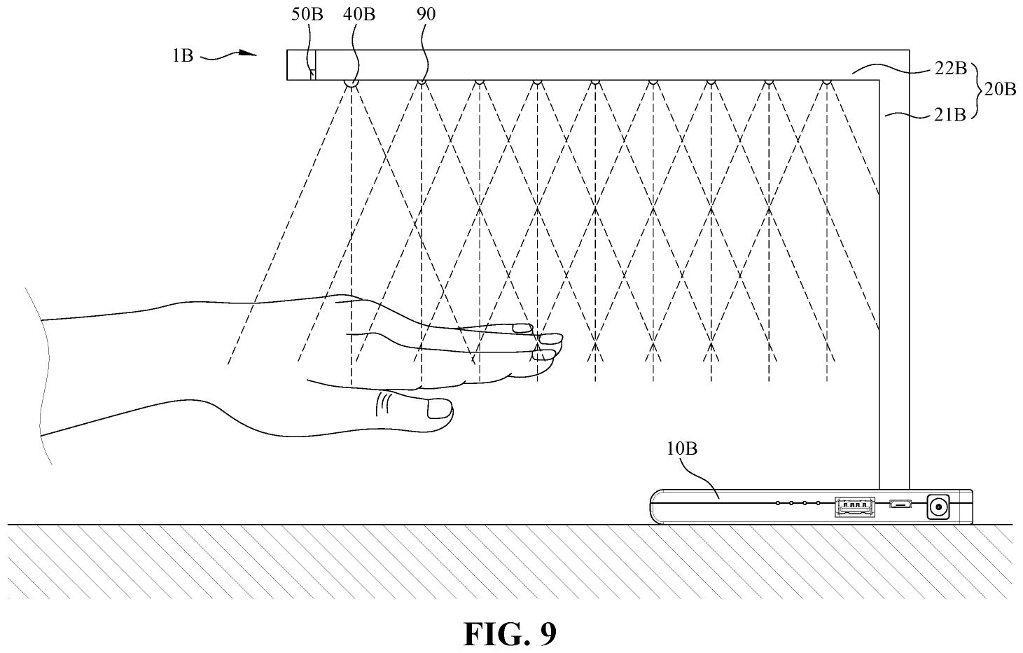

First, as shown in FIG. 9, the base 10B is placed on a table, and the fingers or toes of the user are moved under the light-emitting portion 22B. When the infrared sensor 50B senses the user's finger or toe entering the sensing range, the infrared sensor 50A sends an activation signal to the control module, and the control module turns on the ultraviolet light-emitting diode 40B and the white light-emitting diodes 90 according to the activation signal. At this point, the ultraviolet light emitted from the ultraviolet light-emitting diode 40B irradiates the UV liquid glue on the fingernails or toenails, so that the UV liquid glue is rapidly cured. The white light emitted by the white light-emitting diodes 90 shines on the fingernails or toenails, and the manicurist and the user observe the results of decoration and beautification of the fingernails or toenails.

After the UV liquid glue is completely cured, the user's fingers or toes leave from under the light-emitting portion 22B. When the infrared sensor 50B senses the user's finger or toe exiting the sensing range, the infrared sensor 50B sends a deactivation signal to the control module, and the control module turns off the ultraviolet light-emitting diode 40B and the white light-emitting diodes 90 according to the deactivation signal.

As such, the table lamp shaped manicure device 1B of the third embodiment of the present invention is a common table lamp integrated with the ultraviolet light-emitting diodes 40B, without a cover, and able to automatically sense the finger or toe to enter or leave the sensing range by infrared sensor 50B to turn on and off the ultraviolet light-emitting diode 40B, so that the manicurist when affixing extending nail piece or sticking diamonds or ornaments, can conveniently move the customer's fingers or toes to the underside of the light-emitting portion 22B to automatically perform micro-curing to prevent extending nail piece and stud diamonds or jewelry from dropping.

Furthermore, the table lamp shaped manicure device 1B of the third embodiment of the present invention is capable of simultaneously providing ultraviolet light and white-light to provide, in addition to micro-curing of UV liquid glue applied to fingernails or toenails, also for the manicurists and customers to observe the decoration and beautification of fingernails or toenails.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A table lamp shaped manicure device, comprising:
a base;
a lamp body, comprising a support portion and a light-emitting portion; a bottom end of the support portion being disposed on the base, and the light-emitting portion being disposed at a top end of the support portion;
a substrate, disposed inside the base;
at least an ultraviolet light-emitting diode, disposed on the substrate;
an infrared sensor, disposed on the substrate, and located on the same side of the substrate as the at least an ultraviolet light-emitting diode, and having a sensing range; and
a control module, disposed inside the base and electrically connected to the at least an ultraviolet light-emitting diode and the infrared sensor; and
wherein when the infrared sensor sensing a user's finger or toe entering the sensing range, the infrared sensor transmitting an activation signal to the control module, and the control module turning on the at least an ultraviolet light-emitting diode according to the activation signal;
wherein when the infrared sensor sensing a user's finger or toe exiting the sensing range, the infrared sensor transmitting a deactivation signal to the control module, and the control module turning off the at least an ultraviolet light-emitting diode according to the deactivation signal;

2. The table lamp shaped manicure device according to claim 1, wherein the base, the support portion and the light-emitting portion are all plate-shaped, the bottom end of the support portion is pivotally disposed at one end of the base, and the light-emitting portion is pivotally disposed at a top end of the support portion; a plurality of holes are formed in a bottom surface of the light-emitting portion, and the at least an ultraviolet light-emitting diode and the infrared sensor are disposed corresponding to the holes.

3. The table lamp shaped manicure device according to claim 2, wherein two first through holes are disposed at one end of the base, two first pivot holes are disposed at the bottom end of the support portion, two second pivot holes are disposed at the top end of the support portion, and two second through holes are disposed at one end of the light-emitting portion; the table lamp shaped manicure device further comprises a first pivoting portion and four first pivot axes, and the two ends of the first pivoting portion are respectively disposed with four first insertion holes, wherein the two ends of the two first pivot axes are respectively disposed at the two of the first through holes of the base and two of the first insertion holes of the first pivoting portion, and the two ends of the other two first pivot axes are respectively disposed at the other two first insertion holes of the first pivoting portion and the two second pivot holes of the support portion; and the table lamp shaped manicure device further comprises a second pivoting portion and four second pivot axes, the two ends of the second pivoting portion are respectively disposed with four second insertion holes, wherein the two ends the two second pivot axes are respectively disposed at the two of the second through holes of the support and two of the second insertion holes of the second pivoting portion, and the two ends of the other two second pivot axes are respectively disposed at the other two second insertion holes of the second pivoting portion and the two second through holes of the light-emitting portion.

4. The table lamp shaped manicure device according to claim 1, wherein the support portion has a rod shape and is perpendicular to the base, and the light-emitting portion has a curved shape and is integrally formed with the support portion, and the at least an ultraviolet light-emitting diode and the infrared sensor are disposed at a free end of the light-emitting portion.

5. The table lamp shaped manicure device according to claim 1, wherein each of the support portion and the light-emitting portion has an elongated shape; wherein the table lamp shaped manicure device further comprises at least a white light-emitting diode, the at least a white light-emitting diode is disposed on the substrate, and the at least an ultraviolet light-emitting diode and the infrared sensor are located on the same side of the substrate; and wherein the bottom surface of the light-emitting portion is disposed with a plurality of holes, the at least an ultraviolet light-emitting diode, the infrared sensor, and the at least a white light-emitting diodes emit light through the holes respectively.

6. The table lamp shaped manicure device according to claim 5, wherein the at least a white light-emitting diode is located between the at least an ultraviolet light-emitting diode and a rear end of the light-emitting portion.

7. The table lamp shaped manicure device according to claim 1, further comprising at least a battery disposed inside the base and electrically connected to the control module; and the base comprising at least a USB socket, and the at least a USB socket being electrically connected to the control module.

8. The table lamp shaped manicure device according to claim 7, wherein the base comprises two USB sockets, the two USB sockets are of different types.

9. The table lamp shaped manicure device according to claim 1, wherein the base comprises a power socket, and the power socket is electrically connected to the control module.

10. The table lamp shaped manicure device according to claim 1, wherein the infrared sensor is located between a front end of the light-emitting portion and the at least an ultraviolet light-emitting diode.
